(19) United States
(12) Patent Application Publication
(10) Pub. No.: US 2019/0118514 A1
(43) Pub. Date: Apr. 25, 2019

(54) THERMOFORMED POLYCARBONATE/GLASS LAMINATES AND APPLICATIONS THEREOF

(71) Applicant: SABIC Global Technologies B.V., Bergen op Zoom (NL)

(72) Inventor: Rakshit AMBA, East Greenbush, NY (US)

(21) Appl. No.: 16/064,150

(22) PCT Filed: Dec. 14, 2016
(86) PCT No.: PCT/US2016/066654

§ 371 Date: Jun. 20, 2018

Related U.S. Application Data
(60) Provisional application No. 62/272,765, filed on Dec. 30, 2015.

(51) Int. Cl. B32B 17/06; B32B 7/12; B32B 17/10

(52) U.S. Cl. CPC B32B 17/064; B32B 7/12; B32B 17/10018; B32B 17/10614; B32B 2255/26; B32B 2535/00; B32B 2457/202; B32B 2307/41; B32B 17/10752

(57) ABSTRACT

A laminate and an article of manufacture include a first layer including a polymeric material and a second layer including a glass sheet thermoformed to the first layer. The laminate may include at least one third layer including a polymeric material, the at least one third layer thermoformed to the second layer. The polymeric material in the first layer or the at least one third layer may include a polycarbonate. The laminate and/or article of manufacture may further include at least one functional layer. The at least one functional layer may include an image forming layer, a conductive layer or a touch sensing layer. An electronic device, a sound or moisture barrier, or a medical tray may incorporate the laminate/article of manufacture. Methods for forming the laminate and article of manufacture are also described.

### FIELD OF THE DISCLOSURE

The present disclosure relates to thermoformed laminates, and in particular thermoformed laminates of a polycarbonate material and glass sheet and applications thereof.

### BACKGROUND OF THE DISCLOSURE

An electronic device can have a control panel where a user can interact with the electronic device. The control panel can have layers that can include a display source, a touch sensing device, and/or a cover window disposed over a touch sensing device. The control panel can display information to a user and interpret the user's physical contact with a surface of the control panel. A user can interact with the electronic device by touching the surface of the cover window. An image can be projected through the panel from the display source. The cover window can include glass which can provide a transparent protective layer and can cover the touch sensing device. Glass can be transparent and can be resilient to abrasion and thus can be suitable as a cover window. However, glass can be brittle and susceptible to cracking and failure (e.g., when impacted along an edge). Additionally, it can be difficult for polymer resin to adhere directly to a glass substrate. Additives, surface treatments, and/or adhesives can be used in an effort to improve the adhesion, yet an interface between the glass and the polymer resin can remain a weak point where separation can occur.

These and other shortcomings are addressed by aspects of the present disclosure.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an end view of a thermoformed laminate according to aspects of the present disclosure.

FIG. 2A is a side view of several layers of a laminate prior to thermoforming.

FIG. 2B is a side view of the thermoformed laminate including the layers illustrated in FIG. 2A.

FIG. 3A is a top perspective view of an article of manufacture according to aspects of the present disclosure.

FIG. 3B is a cross section of an article of manufacture taken along line A-A in FIG. 3A.

FIG. 3C is a cross section of an alternative article of manufacture taken along line A-A in FIG. 3A.

FIG. 3D is a cross section of an alternative article of manufacture taken along line A-A in FIG. 3A.

FIG. 4A is a top perspective view of a medical tray according to aspects of the present disclosure.

FIG. 4B is a top perspective view of an article of manufacture illustrating hidden portions according to an aspect of the present disclosure.

### SUMMARY

Aspects of the disclosure relate to a laminate including a first layer comprising a polymeric material and a second layer comprising a glass sheet thermoformed to the first layer.

Other aspects of the disclosure relate to an article of manufacture including a laminate, the laminate comprising a first layer comprising a polymeric material and a second layer comprising a glass sheet thermoformed to the first layer.

Further aspects of the disclosure relate to methods for making an article of manufacture, including thermoforming a glass sheet to a first layer comprising a polymeric material.

### DETAILED DESCRIPTION

Aspects of the disclosure will now be described in detail with reference to the figures, wherein like reference numerals designate identical or corresponding parts throughout the several views, unless specified otherwise.

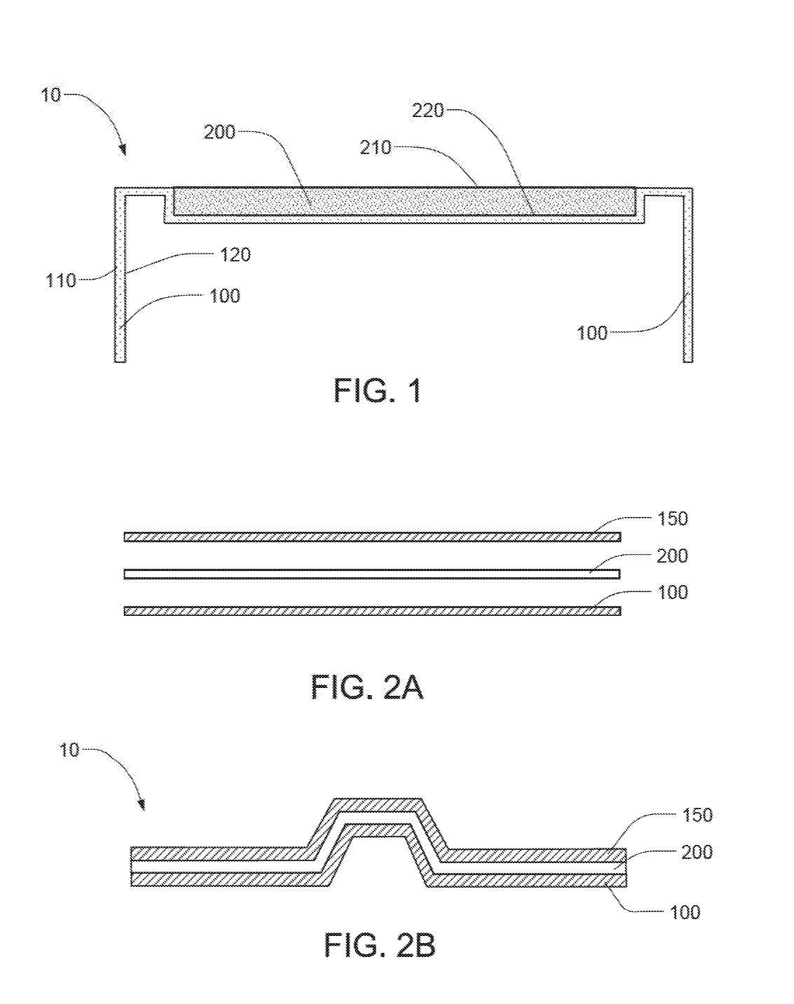

With reference to FIG. 1, an aspect of the present disclosure relates to a laminate 10 including a first layer 100 including a polymeric material and a second layer 200 including a glass sheet to which the first layer 100 is thermoformed.

The laminate 10 can be any shape, such as flat, curved, shaped to conform to a mold or the like. Each of the first layer 100 and the second layer 200 can have a thickness suitable for the article in which the laminate may be located. In certain aspects, each of the first layer 100 and the second layer 200 can have a thickness of from about 0.05 millimeters (mm) to about 5.0 mm thick, such as for example, about 0.05 mm to about 1.5 mm, or from about 0.3 mm to about 1.0 mm, or from about 0.4 mm to 1.0 mm, or even from about 0.55 mm to 0.7 mm as measured in along the shortest dimension of the laminate 10.

The first layer 100 can have a first surface 110 and a second surface 120. Similarly, the second layer 200 can have a first surface 210 and a second surface 220. A surface (e.g., the first surface 110) of the first layer 100 can be thermoformed (e.g. adhered) to a surface (e.g., the second surface 220) of the second layer 200 to form the laminate 10.

A typical thermoforming process involves several steps including but not necessarily limited to: design; materials selection; tooling; thermoforming and trimming. Design involves creating a model (e.g., CAD model) or drawing of the article to be thermoformed, and optimizing the design for the thermoform process. After the final design is ready, the materials to be used for the article are selected. A material is selected based on its functional and aesthetic characteristics. Different materials have different physical properties and benefits, and some may work better for a particular thermoform design than others. Tooling involves creating a mold that the material will be heated in. Molds may be made from various materials; aluminum is one exemplary mold material. When the mold is ready, the article may be thermoformed by forming the selected material to the mold. The material (e.g., polycarbonate resin) is heated to a pliable temperature and then shaped to the mold using vacuum pressure, air pressure or a combination of each. Once the material has been formed to the mold, it is cooled and removed from the mold, retaining its final shape. One benefit of thermoforming is that because the article cools against the mold surface under ambient temperatures, the thermoformed article typically has a much lower residual stress as compared to articles formed by other processes (e.g., injection molding). Finally, once the article is thermoformed and cooled, it may be trimmed or cut into a desired shape. Secondary operations such as cutouts, through-holes and other features that require the removal of material can also be performed on the article.

Accordingly, aspects of the present disclosure relate to a laminate 10 formed by thermoforming a first layer 100 including a polymeric material to a second layer 200 including a glass sheet.

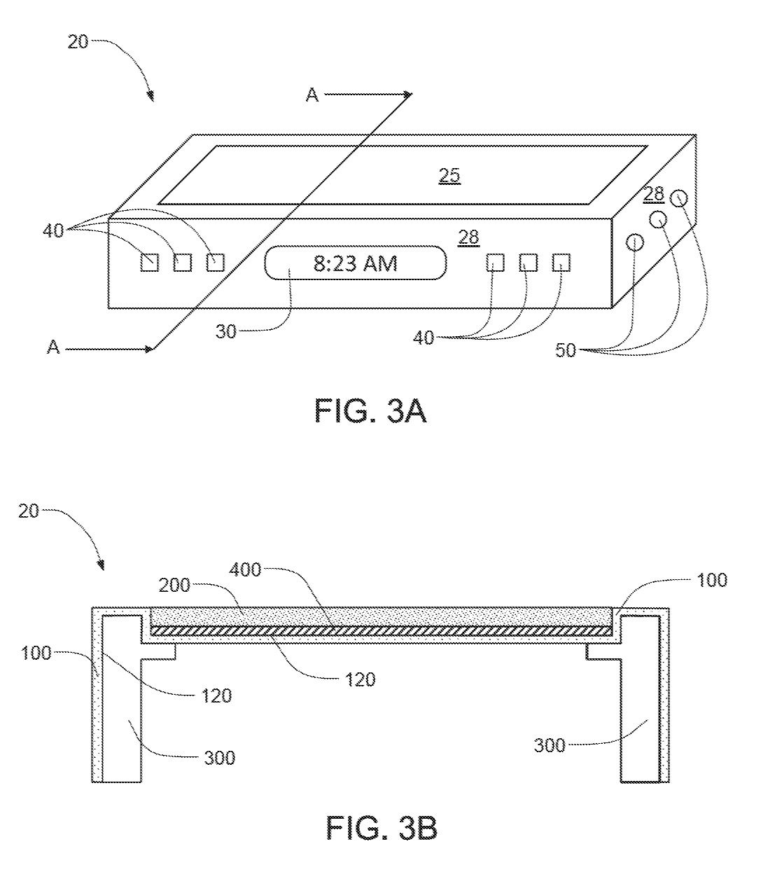

With reference to FIGS. 2A and 2B, in some aspects a laminate 10 includes at least one additional layer (e.g., a third layer) 150 thermoformed to the first layer 100 or the second layer 200. The at least one third layer 150 may also include a polymeric material. The at least one additional layer 150 may be thermoformed to the second layer 200 as illustrated. In such aspects the second layer 200 including the glass sheet would be “sandwiched” between the first layer 100 and the at least one additional (e.g., third) layer 150. In other aspects the at least one additional layer 150 could be thermoformed to the first layer 100 (not shown).

Thermoforming of the second layer 200 including the glass sheet between two layers (e.g., first layer 100 and at least one additional layer 150) may in some aspects result in cracking of the glass sheet in the second layer 200. Cracking of the glass sheet in the second layer 200 may result in the second layer having an opaque appearance, so it may also be desirable for the first layer 100 and/or the at least one additional layer 150 to have an opaque appearance so that the cracked glass in the second layer 200 would not be visible.

In some aspects (not illustrated), a plurality of additional layers 150 are thermoformed to the first layer 100 or the second layer 200. Thus, not including any adhesive layers or functional layer(s) (described below), the laminate 10 may include a third layer, a fourth layer, a fifth layer, etc.

A thermoformed laminate 10 including a first layer 100, a second layer 200 including a glass sheet, and at least one additional (third) layer 150 may be useful in a wide variety of applications. The second layer 200 including the glass sheet would have a different density than the first layer 100 and the at least one additional layer 150, and would thus provide the laminate 10 with good sound and moisture barrier properties. Accordingly, in one particular example the laminate 10 could be incorporated into an automotive panel, such as a dashboard. Another benefit of such a laminate 10 is that it would provide sound and moisture barrier properties at a relatively light weight compared to current dashboard materials used in the industry.

In some aspects the laminate 10 includes at least one adhesive layer 400, which provides additional adhesive strength between the layers of the laminate 10 in which the at least one adhesive is located. The at least one adhesive layer 400 can thus be disposed adjacent to a surface of the laminate 10. For example, the at least one adhesive layer 400 can be disposed between the first layer 100 and the second layer 200, or between the second layer 200 and the at least one additional (e.g., third) layer 150, or between the first layer 100 and the at least one additional layer 150. In certain aspects a plurality of adhesive layers 400 could be provided, for example between the first layer 100 and the second layer 200, and between the second layer 200 and the at least one additional layer 150.

The at least one adhesive layer 400 can be applied with any thickness suitable to ensure that the layer(s) of the laminate are sufficiently adhered to one another. In some aspects, the thickness of the at least one adhesive layer 400 is less than about 2.0 mm, for example, about 0.05 mm to about 1.0 mm, or about 0.2 mm to about 0.8 mm. The at least one adhesive layer 400 can be sandwiched between, e.g., the first surface 110 of the first layer 100 and the second surface 220 of the second layer 200. The at least one adhesive layer 400 can be in mechanical communication with, e.g., the first surface 110 of the first layer 100 and the second surface 220 of the second layer 200. The at least one adhesive layer 400 can be applied to, e.g., the first layer 100, or to the second layer 200, or to both the first layer 100 and the second layer 200. The at least one adhesive layer 400 can be applied using any desirable process including but not limited to roll lamination, roller coating, screen printing, spreading, spray coating, spin coating, dipping, a combination thereof and/or the like.

The adhesive in the at least one adhesive layer 400 can be any adhesive that can withstand exposure to a molding process (e.g., exposure to a mold tool temperature of up to 200° C. and/or molding material temperature of up to 360° C.) and which will not chemically attack the first layer 100 or the second layer 200. Chemical attack can be determined by forming a sample that includes the selected adhesive and comparing the physical properties of the sample before and after it is placed in a 1700-2000 pound per square inch (psi, gauge) (11.7 to 13.8 MegaPascal (MPa)) strain fixture and held at a temperature of 70° C. for 1 week. If the mechanical properties (e.g., tensile strength, flexural modulus, and the like) are greater than or equal to 95% of their original value (before the 1 week test) and there are no visual signs of attack (e.g., stress cracks) then the adhesive can be considered to not attack the substrate material. In aspects of the present disclosure, the adhesive is a hindered amine light stabilizer free ethyl vinyl acetate (HALS free EVA), thermal plastic urethane (TPU), epoxy, acrylate, amine, urethane, silicone, ethyl vinyl acetate (EVA), or a combination thereof.

The adhesive can be optically clear, such as providing a transmittance of visible light of greater than or equal to 90% as determined per ASTM D1003-00. The adhesive can be opaque, such as colored to match the first layer 100 or the second layer 200. The first layer 100 or the second layer 200 can be opaque, or can be optically clear such as providing a transmittance of visible light of greater than or equal to 90% as determined per ASTM D1003-00. The adhesive can include a polymer, such as a thermosetting polymer or a thermoplastic polymer. The thermosetting polymer can be activated by electromagnetic radiation (e.g., electromagnetic radiation in the ultraviolet (UV) spectrum having frequencies of 750 THz to 30 PHz), electron beam, heat, drying, exposure to air, pressure (e.g., pressure sensitive adhesives) or a combination thereof. The adhesive can be applied between the first layer and the second layer to couple them together so as to prevent separation. When the layers are coupled in this way, the first layer 100 can exhibit an adhesion to the second layer 200 of greater than 3 lbf (pounds force) per linear inch (525 Newtons per meter (N/m)) as determined by a 90 degree peel test.

As discussed, the laminate 10 includes a first layer 100 including a polymeric material, and optionally at least one additional (third) layer 150 that may also include a polymeric material. In some aspects each of the polymeric material of the first layer 100 and at least one additional layer 150 independently includes a thermoplastic polymer, a thermoset polymer, or a combination thereof. Possible thermoplastic polymers include, but are not limited to, oligomers, polymers, ionomers, dendrimers, copolymers such as graft copolymers, block copolymers (e.g., star block copolymers, random copolymers, and the like) or a combination thereof. Examples of such thermoplastic resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (PI) (e.g., polyetherimides (PEI)), acrylonitrile-styrene-butadiene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluorides (PVF), polyvinylidene fluorides (PVDF), fluorinated ethylene-propylenes (FEP), polyethylene tetrafluoroethylenes (ETFE)), polyethylene naphthalates (PEN), cyclic olefin copolymers (COC), or a combination thereof.

More particularly, a thermoplastic resin can include, but is not limited to, polycarbonate resins (e.g., LEXAN™ resins, including LEXAN™ CFR resins, commercially available from SABIC's Innovative Plastics business), polyphenylene ether-polystyrene resins (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate resins (e.g., XENOY™ resins, commercially available from SABIC's Innovative Plastics business), copolyestercarbonate resins (e.g., LEXAN™ SLX resins, commercially available from SABIC's Innovative Plastics business), or a combination thereof. Even more particularly, the thermoplastic resins can include, but are not limited to, homopolymers and copolymers of a polycarbonate (e.g., LEXAN™ FST), a polyester, a polyacrylate, a polyamide, a polyetherimide, a polyphenylene ether, or a combination thereof. The polycarbonate can include copolymers of polycarbonate (e.g., polycarbonate-polysiloxane, such as polycarbonate-polysiloxane block copolymer, polycarbonate-dimethyl bisphenol cyclohexane (DMBPC) polycarbonate copolymer (e.g., LEXAN™ DMX and LEXAN™ XHT resins commercially available from SABIC's Innovative Plastics business), polycarbonate-polyester copolymer (e.g., XYLEX™ resins, commercially available from SABIC's Innovative Plastics business)), linear polycarbonate, branched polycarbonate, end-capped polycarbonate (e.g., nitrile end-capped polycarbonate), or a combination thereof, for example, a combination of branched and linear polycarbonate.

In some aspects of the disclosure, the polycarbonate resin is a high purity polycarbonate resin. High purity polycarbonate resins are generally characterized as having a purity of at least about 99.70%, a hydroxyl content less than 100 parts per million (ppm) by weight, and which contains less than 2 ppm sulfur, although other purity criteria could be applied. In certain aspects, the polycarbonate resin included in molded articles of the disclosure is produced from a bisphenol A polymer having a purity of at least about 99.70%, a hydroxyl content less than 100 ppm by weight, and which contains less than 2 ppm sulfur.

As discussed, the laminate 10 includes a second layer 200 including a glass sheet. In some aspects the glass in the glass sheet includes chemically strengthened glass (e.g., CORNING™ GORILLA™ Glass commercially available from Corning Inc., XENSATION™ glass commercially available from Schott AG, DRAGONTRAIL™ glass commercially available from Asahi Glass Company, LTD, and CX-01 glass commercially available from Nippon Electric Glass Company, LTD, this list is not inclusive of all chemically hardened glass products). The glass could also include non-strengthened glass, such as non-hardened glass including low sodium glass (e.g., CORNING™ WILLOW™ Glass commercially available from Corning Inc. and OA-10G Glass-on-Roll glass commercially available from Nippon Electric Glass Company, LTD, this list is not inclusive of all non-hardened glass products). The glass sheet in the second layer 200 can include sapphire glass commercially available from GT Advanced Technologies Inc. In some aspects, the glass sheet in the second layer 200 can include GORILLA™ glass.

Any of the layers described herein (including the first layer 100, second layer 200, or at least one additional layer 150) can also include a filler material such as a reinforcing fiber (e.g., carbon fiber filled polycarbonate resin such as LNP™ THERMOCOMP™ Compound, commercially available from SABIC's Innovative Plastics business). Other suitable filler materials include, but are not limited to, carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), or a combination thereof.

Any of the layers described herein (including the first layer 100, second layer 200, or at least one additional layer 150) can be decorated on any of their surfaces (e.g., the first surface 110 or the second surface 120 of the first layer 100) using any of a number of decorating techniques including but not limited to screen printing, pad printing, metallization, digital printing, gravure printing, offset printing, laser marking, laser printing, etching, texturing, and the like.

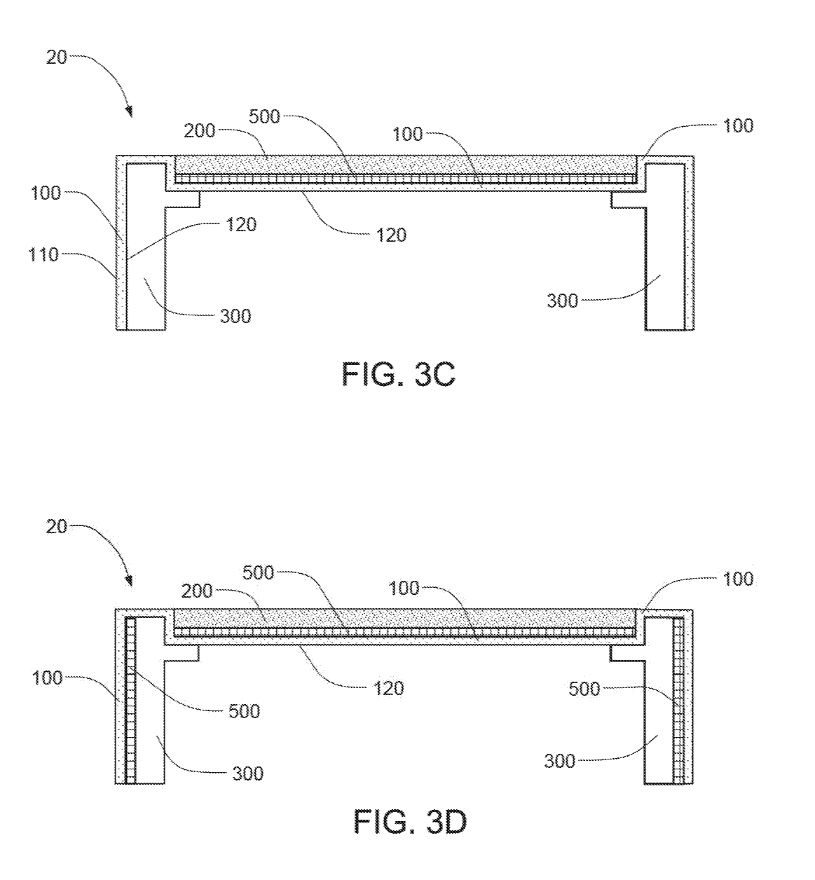

With reference to FIGS. 3A-3D, certain aspects of the present disclosure relate to an article 20, the article 20 including the laminate 10 and at least one molded component 300 adhered to the laminate 10. Aspects of the laminate 10 associated with the article 20 are described above. FIG. 3A illustrates an exemplary article 20, and FIG. 3B is a cross section taken at line A-A of the article 20 of FIG. 3A.

The at least one molded component 300 can include any suitable material, including but not limited to thermoplastic, glass, wood, metal, ceramic, stone, reinforcing fiber, and combinations thereof. Suitable reinforcing fibers include but are not limited to carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), and combinations thereof.

The at least one molded component 300 can be any shape. The at least one molded component 300 can be bonded to the laminate 10, such as the first layer 100 of the laminate. In this way, the at least one molded component 300 can be bonded with strong adhesion to the first layer 100 which in turn can be adhered to the second layer 200 with strong adhesion (e.g., a adhesion value of 3 lbf per linear inch as determined by a 90 degree peel test or as determined by temperature cycling at −40° C. to 85° C. at 85% RH with 1 hour dwells at each temperature for 10 to 50 cycles, or by submersing the sample in boiling water for between 5 and 20 minutes, and then checking for signs of delamination).

The at least one molded component 300 can be molded to the laminate 10 in a molding process. For example, the laminate 10 including the first layer 100 and second layer 200 can be positioned in a mold cavity and a polymeric material of the at least one molded component 300 can be injected into the mold cavity to bond to the first layer 100 of the laminate 10 to form the article 20. The molding process can incorporate known technologies within the art such as injection molding, injection compression molding, gas assist molding, foam molding, multi shot molding, multi stage molding, compression molding, or a combination thereof. Tooling that improves flow, surface finish, and weld strength of knit lines within a molded part such as induction heating and heat/cool technology can be used to reduce injection pressures, improve surface finishes, and promote improved bond strength between the at least one molded component 300 and the laminate 10. The laminate 10 can be held in position within the mold cavity during the molding process using any technique known in the art. The laminate 10 can be held in place by a pressure differential such as vacuum applied to an area of the laminate 10 through passages in a mold section. The laminate 10 can be held in place by pins extending from a mold section into the mold cavity. The pins can be spring loaded to ensure sufficient pressure is applied to the laminate 10 to maintain its position during the molding operation. Spring loaded pins can account for variation in the thickness of the laminate 10 from part to part during production of multiple articles. The laminate 10 can be held in place by a static charge. The laminate 10 can be held in place by core shutoffs that can extend out from the cavity and can form a feature (not illustrated) that the laminate 10 can fit over. The laminate 10 can be held in place by closing the core side of the tool onto the laminate and thus creating a shutoff between the core, cavity, and laminate 10 over an area or a multitude of areas. The laminate 10 can be held in place by a combination of pins, static, shutoffs, mold features, and pressure differential as described above.

The at least one molded component 300 can include a polymer, a filler material, a polymer additive, or a combination thereof. Suitable filler materials include materials such as those described above. In some aspects the filler material includes reinforcing fiber. The filler material can be in any desirable form for use in a molding operation, such as chopped filler material. The at least one molded component 300 can include 0.1 to 50 weight percent (wt. %) filler material, for example, 5 wt. % to 40 wt. %, or, 15 wt. % to 30 wt. %, or, 20 wt. %. In an aspect, the at least one molded component 300 can include 5 wt. % to 25 wt. % carbon fiber, or 20 wt. %. In an aspect, the at least one molded component 300 can include 5 wt. % to 40 wt. % glass fiber or glass bead, or 30 wt. %. Incorporating a filler material can reduce shrinkage of the at least one molded component 300 after a molding operation, which can prevent the article 20 from undesirable warping. When the at least one molded component 300 is molded from unfilled polymeric resin, the article 20 can be placed in a fixture after molding to prevent it from warping.

While not required, the at least one molded component 300 can be adhered to the laminate with an adhesive layer. The adhesive in the adhesive layer can be any of the adhesive materials described herein. The adhesive layer may be located between the at least one molded component 300 and the laminate 10 (e.g., between the at least one molded layer and the first layer 100 of the laminate). The adhesive layer, when included, may enhance the bond between the at least one molded component 300 and the laminate 10. In some aspects an adhesive layer may be omitted, such as when the materials of the laminate 10 and at least one molded component 300—and the manner of adhering the laminate to the at least one molded component—result in a strong enough bond that an additional adhesive is not required.

With further reference to FIGS. 3C and 3D, in some aspects the laminate 10 and/or the article 20 includes at least one functional layer 500 that provides additional features to the laminate 10 or to the article 20. The at least one functional layer 500 may be adhered to the laminate 10, such as to the first layer 100 and/or the second layer 200 of the laminate 10. An adhesive layer including an adhesive such as one or more of those described herein may be included between the at least one functional layer 500 and the laminate 10 and/or at least one molded component 300 as desired or required. FIGS. 3C and 3D illustrate exemplary aspects of articles 20, and are cross sections taken along line A-A of the article of FIG. 3A.

In certain aspects the at least one functional layer 500 is an ultraviolet light protection layer, a touch sensing layer, an abrasion resistant layer, an infrared absorbing layer, an infrared reflecting layer, a hydrophobic layer, a hydrophilic layer, an anti-fingerprint layer, an anti-smudge layer, an antimicrobial layer, a conductive layer, an electromagnetic interference shielding layer, an anti-frost layer, an anti-fog layer, an image forming layer, or a combination thereof. The at least one functional layer 500 may include at least one of a film, a coating, a coextruded layer, a deposited layer or a molded layer.

In some aspects, the at least one functional layer 500 includes a conductive coating as is described in International Application No. PCT/IB2015/052885 and International Application No. PCT/IB2015/02884, the entirety of each is incorporated herein by this reference. Furthermore, the conductive coating can be transferred to the first layer 100 or second layer 200 with a transfer resin as described in International Application No. PCT/IB2015/052885. For example, the at least one functional layer 500 can include a conductive coating formed from conductive nanoparticles, including conductive nanoparticles, conductive metal nanowires, carbon allotropes such as carbon nanotubes, graphene, etc., and combinations thereof. Metal nanoparticles can include copper and silver nanoparticles. A metal mesh film can be used having a regular network. Transmittance can be about 70% to about 80% and resistance, measured in Ohm/square can be less than 0.5. Conductive coatings can be formed from conductive metal nanoparticles formed into a patterned network of conductive traces and transparent cells, i.e., voids having few nanoparticles. The network can be random or regular in shape, the transmittance can be about 70%, and the resistance can be less than 0.05 Ohm/square. The transparent cells can have sizes of less than 1 mm, for example, less than 0.5 mm, for example, less than 0.25 mm. Transparent conductive coatings are described, for example, in U.S. Pat. No. 7,601,406, the entirety of which is incorporated herein by this reference.

The conductive coating (e.g., conductive metal nanoparticle layers) can be applied to a substrate by several techniques, including, printing of conductive inks (e.g., flexographic, screen printing, inkjet, gravure), coating and patterning of e.g., silver halide emulsions which can be reduced to silver particles, coating of conductive nanowire dispersions, and self-assembly of silver nanoparticle dispersions or emulsions.

The conductive coating as disclosed herein can be used in any electronic device having a touch sensing device. For example these conductive coatings can be used in: electronic displays such as televisions, desktop computer displays, public information displays, educational displays, automotive displays, smart windows; mobile electronic devices such as cell phones, portable computers, tablet computers, wearable electronic devices, such as watches, bands, portions of clothing or other textiles incorporating electronics including touch sensing features; transparent EMI shielding applications, and capacitive sensing applications (such as applications having touch sensing controls).

The conductive coating can contain an EMI shielding material. The conductive coating can include pure metals such as silver (Ag), nickel (Ni), copper (Cu), or similar shielding metal, metal oxides thereof, combinations thereof, and metal alloys including at least one of the foregoing, or metals or metal alloys produced by the Metallurgic Chemical Process (MCP) described in U.S. Pat. No. 5,476,535, the entirety of which is incorporated herein by this reference. Metal particles of the conductive coating can be nanometer sized, e.g., such as where 90% of the particles can have an equivalent spherical diameter of less than 100 nanometers (nm). The metals of the conductive coating can form a network of interconnected metal traces defining openings on the substrate surface to which it is applied. The surface resistance of the conductive coating can be less than or equal to 1.0 ohm per square (ohm/sq). A conductive coating can have an EMI shielding effectiveness from 30 megahertz (MHz) to 1.5 gigahertz (GHz) as determined per ASTM D4935 of greater than 25 decibel (dB), for example, 30 dB to 80 dB, or, 40 dB to 80 dB. The conductive coating can include carbon based particles arranged in a network, e.g., carbon based particle with a metal mesh. The conductive coating including carbon based particles can be arranged in a regular network. The conductive coating including carbon based particles can be arranged in an irregular network. The carbon based particles can include graphene, carbon nanotubes, or a combination thereof.

The conductive coating as disclosed herein can be used in any electronic device having a touch sensing device. For example these conductive coatings can be used in: electronic displays such as televisions, desktop computer displays, public information displays, educational displays, automotive displays, smart windows; mobile electronic devices such as cell phones, portable computers, tablet computers, wearable electronic devices, such as watches, bands, portions of clothing or other textiles incorporating electronics including touch sensing features; transparent EMI shielding applications, and capacitive sensing applications (such as applications having touch sensing controls).

In some aspects the at least one functional layer 500 includes an image forming layer, a conductive layer and/or a touch sensing layer. In certain aspects the image forming layer, conductive layer and/or touch sensing layer is a liquid crystal display.

The laminate 10 or the article 20 including at least one functional layer 500 thermoformed thereto will thus have functional features corresponding to features provided by the at least one functional layer 500. In some aspects the at least one functional layer 500 may be incorporated into one or more sides of the article 20, as shown in FIGS. 3C and 3D. As noted, these FIGS. are cross sections of the article of FIG. 3A, which is an exemplary electronic device (e.g., mobile phone). Most mobile phones include an image forming layer, a conductive layer and/or a touch sensing layer on the main surface of the phone, but aspects of the present disclosure offer the ability to include these layers on other surfaces (such as one or more sides) of the article 20. As shown in purely exemplary FIG. 3A, an image forming layer, a conductive layer and/or a touch sensing layer is located on one or more sides of the phone and is visible through the first layer 100, and could display various information on one or more sides of the phone. The electronic device thus includes a primary first surface 25 and at least one second surface 28 extending from the primary first surface 25 at an angle. The laminate 10 including the at least one functional layer 500 overlies both the primary first surface 25 and the at least one second surface 28 such that the at least one functional layer 500 is operable on both the primary first surface 25 and the at least one second surface 28. The at least one second surface 28 can thus display information, such as but not limited to the time 30, lights 40, 50 that flash when the phone rings or when a message is received or the like.

In addition to the foregoing components, the one or more of the disclosed components (e.g., the first layer 100, the second layer 200, the at least one molded component 300, the at least one adhesive layer 400 and the at least one functional layer 500) can optionally include an effective amount of one or more additional additive materials ordinarily incorporated in articles of this type, with the proviso that the additives are selected so as to not significantly adversely affect the desired properties of the article. Combinations of additives can be used. Such additives can be combined with the other components at a suitable time during the mixing of the components prior to or during the thermoforming process. Exemplary and non-limiting examples of additive materials that can be present in the disclosed molded article include fillers, reinforcing materials, acid scavenger, anti-drip agent, antioxidant, heat stabilizer, antistatic agent, chain extender, colorant (e.g., pigment and/or dye), carbon black, organic dye(s), surface effect additives, radiation stabilizer, de-molding agent, flow promoter, lubricant, mold release agent, plasticizer, quenching agent, flame retardant, hydrolytic stabilizer, ultraviolet (UV) light stabilizer, UV reflecting additive, or any combination thereof. The total amount of additives (other than any impact modifier, filler, or reinforcing agents) is generally 0.01 to 5 wt. %, based on the total weight of the composition.

The reinforcing material can include aramid, carbon, basalt, glass, plastic (e.g., thermoplastic polymer, thermoset polymer), quartz, boron, cellulose, or natural fibers, as well as combinations thereof, such as high stiffness inorganic fibers (e.g., glass, carbon, quartz, boron, and combinations thereof). High stiffness refers to a tensile modulus of greater than or equal to 35 GigaPascals (GPa). For example, the fibers can be formed of liquid crystal polymer, high tenacity polymer (e.g., polypropylene, polyethylene, poly(hexano-6-lactam), poly[imino(1,6-dioxohexamethylene) imnohexamethylene]), as well as combinations thereof. An exemplary fiber filled resin is LEXAN™ resin, commercially available from SABIC Innovative Plastics. Another exemplary fibrous material can include fiber reinforced thermoplastics such as ULTEM™ resins, commercially available from SABIC Innovative Plastics). For example, a variety of reinforcement fibers may be used for the outer layers. For example, E-glass, S-glass and various carbon based systems, and combinations thereof, may be employed, e.g., a glass (e.g. E-glass)—carbon hybrid fabric. The outer layer can have a different reinforcing material than the core layer. Certain enclosure applications may need radio frequency transparency. Thus, glass reinforcement can be used in the outer layer in these applications. An exemplary reinforcing material (e.g., for the outer layers) is Tencate CETEX TC925 FST or Tencate CETEX TC1000 commercially available from Ten Cate Advanced Composites.

Light stabilizers and/or ultraviolet light (UV) absorbing stabilizers can also be used. Exemplary but non-limiting light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or combinations thereof. Light stabilizers are generally used in amounts of 0.01 to 5 parts by weight, based on 100 parts by weight of the total composition, excluding any filler.

Exemplary but non-limiting UV light absorbing stabilizers include triazines, dibenzoylresorcinols (such as TINUVIN™ 1577 commercially available from BASF and ADK STAB LA-46 commercially available from Asahi Denka), hydroxybenzophenones; hydroxybenzotriazoles; hydroxyphenyl triazines (e.g., 2-hydroxyphenyl triazine); hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3 diphenylacryloyl)oxy]methyl]propane; nano-size inorganic materials such as titanium oxide, cerium oxide, and zinc oxide, all with a particle size less than or equal to 100 nanometers, or combinations thereof. UV light absorbing stabilizers are generally used in amounts of 0.01 to 5 parts by weight, based on 100 parts by weight of the total composition, excluding any filler.

The laminates 10 and articles 20 can transmit greater than or equal to 50% (e.g. 50 percent transmittance) of incident visible light (e.g., electromagnetic radiation (EMR) having a frequency of 430 THz to 790 THz) through a cross section, for example, 60% to 100%, or, 70% to 100%. A transparent polymer, substrate, adhesive, and/or material of the article can transmit greater than or equal to 50% of incident visible light, for example, 75% to 100%, or, 90% to 100%. Percent transmittance for laboratory scale samples can be determined using ASTM D1003-13 (Standard Test Method for Haze and Luminous Transmittance of Transparent Plastics).

The laminate 10 and article 20 disclosed herein can successfully pass an industry standard push-out test. Such a push out test can involve applying a load onto a surface (e.g., first surface 110 of the first layer 100) while simultaneously resisting this load at an interface of the laminate 10 and the at least one molded component 300 in an attempt to disconnect the at least one molded component 300 and the laminate 10. The applied load can be greater than or equal to 1 lbf (4.4 N), for example 1 lbf to 3 lbf (4.4 N to 13.3 N), or greater than or equal to 5 lbf (22.2 N). The article 20 can successfully pass a thermal cycling test. A thermal cycling test can include subjecting the article 20 to a temperature of −40° C. for 60 minutes, then increasing the temperature at a rate of 3-5° C./minute until the article 20 reaches a temperature of 85° C. where it is maintained for 60 minutes, followed by decreasing the temperature at a rate of 3-5° C./minute until the article 20 reaches a temperature of −40° C. This cycling can be repeated for 10 to 100 cycles. Once completed, the degree to which the laminate 10 is separated from the at least one molded component 300 is determined. A passing result includes an absence of delamination between the laminate 10 and at least one molded component 300 and at the interface. The article 20 can pass a 90 degree peel test where the at least one molded component 300 is peeled at a 90 degree angle relative to a surface where the laminate 10 is coupled to the at least one molded component 300 with a force of greater than or equal to 5 lbf per linear inch (875 N/m).

The disclosed article can find wide use in any application where it can be desirable to thermoform a glass sheet within a laminate and/or adhere a molded component to the laminate. Applications can include electronic devices (e.g., mobile phones, laptop computers, electronic tablets, e-readers, televisions, computer monitors, touch displays, and the like), automotive components, home appliances, refrigerator shelves, medical devices, office furniture, building materials, construction materials, eye wear, face shields, and the like. For example, these articles can be used in housings, bezels, control panels, display panels, windows, covers, trim pieces, support elements, and the like. In some aspects these articles can be used in any window applications, such as for electronic devices, buildings, vehicles, home appliances, medical devices, and the like. In an aspect, the article can form a housing for an electronic device where an electronic component is disposed within the article (e.g., a mobile phone, electronic tablet, e-reader, and the like). In an aspect, the article can form an automotive interface such as a radio bezel, heat/ventilation/air conditioner bezel (e.g., heating vent bezel, ventilation bezel, air conditioning bezel, or the like), rocker button, instrument cluster, or a combination thereof.

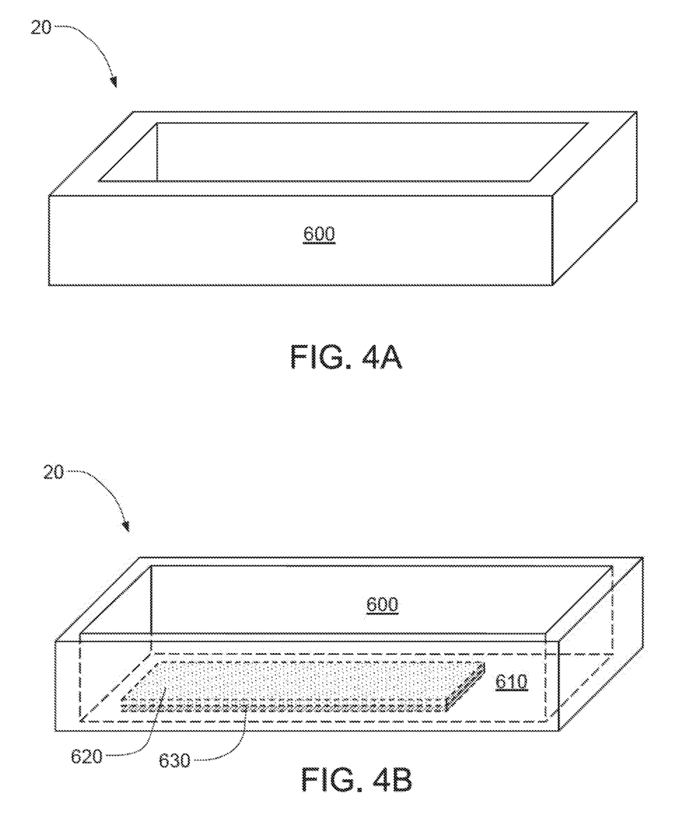

In one particular aspect illustrated in FIGS. 4A and 4B, the article 20 is a medical tray 600 including a base layer 610 and a second layer 620 including a glass sheet thermoformed to the base layer 610. The base layer 610 includes a polymeric material such as any of those described herein. In one particular aspect, the base layer 610 includes a polyetherimide resin such as ULTEM™ resin. The glass sheet in the second layer 620 may include any of the glass materials described herein. An optional adhesive layer 630 may be located between the base layer 610 and the second layer 620. The adhesive in the adhesive layer 630 may include any of the adhesive materials described herein. By including a second layer 620 including a glass sheet in the medical tray 600 as thus described, the medical tray 600 includes a barrier between the base layer 610 and the equipment, fluids or other materials added to the medical tray 600, which protects the polymeric material in the base layer 610 from absorption of contaminants. The second layer 620 including the glass sheet may also provide one or more of scratch resistance, transparency, sound absorption, dampening, rust prevention and heat dissipation properties to the medical tray 600. Further, a medical tray 600 according to aspects described herein would have a lighter weight than metal trays currently in use in the industry. In one particular aspect, the medical tray 600 is a surgical tray.

The present disclosure also relates to methods for making the laminate 10 and the article 20 of manufacture. In one aspect, the method includes thermoforming a glass sheet (i.e., second layer 200) to a first layer 100 including a polymeric material. Aspects of thermoforming are as described herein. In some aspects the method includes thermoforming at least one additional layer (e.g., a third layer) 150 including a polymeric material to the glass sheet/second layer 200. The polymeric material in the first layer 100 or the at least one third layer 150 may include polycarbonate. One or more adhesive layers 400 may be applied between the layers of the laminate 10, such as between the first layer 100 and the second layer/glass sheet 200 or between the second layer/glass sheet 200 and the additional/third layer 150. In certain aspects at least one functional layer 500 may be applied to the laminate 10. The at least one functional layer may be disposed between the first layer 100 or the second layer/glass sheet 200 or between the second layer/glass sheet 200 and the at least one additional/third layer 150.

A molded component 300 such as that described above may be adhered to the laminate 10 to form the article 20. In some aspects the article 20 is an electronic device, a sound or moisture barrier, or a medical tray 600. The electronic device may include at least one functional layer 500 including a conductive layer or a touch sensing layer. The electronic device may include a primary first surface 25 and at least one second surface 28 extending from the primary first surface 25 at an angle. The laminate may overlie both the primary first surface 25 and the at least one second surface 28 such that the conductive layer or touch sensing layer is operable on both the primary first surface 25 and the at least one second surface 28.

In other aspects the article 20 is a sound or moisture barrier and includes at least one third layer 150, and at least one of the first layer 100, the glass sheet/second layer 200 and at least one third layer 150 is opaque. In yet a further aspect the article 20 is a medical tray 60 including a base layer 610, and the laminate 10 is thermoformed to the base layer 610.

In the methods described herein, the laminate 10, the article 20 and the various components in the laminate 10/article 20 (including but not limited to the first layer 100, second layer/glass sheet 200, at least one additional layer 150, at least one molded component 300, at least one adhesive layer 400, and at least one functional layer 500) may have any form and composition described above.

### EXAMPLES

It should be appreciated that the present disclosure can include any one up to all of the following examples:

### Example 1

A laminate comprising a first layer comprising a polymeric material and a second layer comprising a glass sheet thermoformed to the first layer.

### Example 2

The laminate of Example 1, further comprising at least one third layer comprising a polymeric material, the at least one third layer thermoformed to the second layer.

### Example 3

The laminate according to Example 1 or 2, wherein the polymeric material in the first layer or the at least one third layer comprises polycarbonate.

### Example 4

The laminate according to any of the previous Examples, further comprising at least one adhesive layer disposed between the first layer and the second layer or between the second layer and the third layer.

### Example 5

The laminate according to Example 4, wherein the at least one adhesive layer comprises epoxy, acrylate, amine, urethane, silicone, thermal plastic urethane, ethyl vinyl acetate, HALS free EVA, or a combination thereof.

### Example 6

The laminate according to any of the previous Examples, wherein the laminate further comprises at least one functional layer.

### Example 7

The laminate according to Example 6, wherein the at least one functional layer is disposed between the first layer or the second layer or between the second layer and the at least one third layer.

### Example 8

The laminate according to Examples 6 or 7, wherein the at least one functional layer comprises an ultraviolet light protection layer, a touch sensing layer, an abrasion resistant layer, an infrared absorbing layer, an infrared reflecting layer, a hydrophobic layer, a hydrophilic layer, an anti-fingerprint layer, an anti-smudge layer, an antimicrobial layer, a conductive layer, an electromagnetic interference shielding layer, an anti-frost layer, an anti-fog layer, an image forming layer, or a combination thereof.

### Example 9

The laminate according to any of Examples 6 to 8, wherein the at least one functional layer comprises at least one of a film, a coating, a coextruded layer, a deposited layer or a molded layer.

### Example 10

The laminate according to any of Examples 6 to 9, further comprising at least one additional adhesive layer disposed between the at least one functional layer and at least one of the first layer, the second layer and the at least one third layer.

### Example 11

The laminate according to any of Examples 6 to 10, wherein the at least one additional adhesive layer comprises epoxy, acrylate, amine, urethane, silicone, thermal plastic urethane, ethyl vinyl acetate, HALS free EVA, or a combination thereof.

### Example 12

The laminate according to any of Examples 6 to 11, wherein the at least one functional layer comprises an image forming layer, a conductive layer or a touch sensing layer.

### Example 13

The laminate according to Example 12, wherein the image forming layer, conductive layer or touch sensing layer is a liquid crystal display.

### Example 14

The laminate according to any of the previous Examples, wherein at least one of the first layer, the second layer or the at least one third layer is opaque.

### Example 15

The laminate according to any of the previous Examples, wherein the polymeric material in the first layer or the third layer comprises polycarbonate, polyphenylene ether-polystyrene, polyetherimide, polybutylene terephthalate-polycarbonate, copolyestercarbonate, polyester, polyacrylate, polyamide, polyetherimide, polyphenylene ether, or a combination thereof.

### Example 16

The laminate according to any of the previous Examples, wherein the first layer, the second layer or the third layer comprises a filler material.

### Example 17

The laminate according to Example 16, wherein the filler material comprises carbon fiber, glass fiber, aramid fiber, basalt fiber, quartz fiber, boron fiber, cellulose fiber, natural fiber, liquid crystal polymer fiber, high tenacity polymer fiber, or a combination thereof.

### Example 18

An electronic device incorporating the laminate according to any of the previous Examples, wherein the electronic device comprises a mobile phone, an electronic tablet, an e-reader, a lap top computer, a desktop computer, a speaker, or a combination thereof.

### Example 19

A sound or moisture barrier incorporating the laminate according to any of the previous Examples.

### Example 20

A medical tray incorporating the laminate according to any of the previous Examples, wherein the laminate is thermoformed to the medical tray.

### Example 21

An article of manufacture comprising a laminate, the laminate comprising a first layer comprising a polymeric material and a second layer comprising a glass sheet thermoformed to the first layer.

### Example 22

The article of Example 21, further comprising at least one third layer comprising a polymeric material, the at least one third layer thermoformed to the second layer.

### Example 23

The article according to Example 21 or 22, wherein the polymeric material in the first layer or the at least one third layer comprises polycarbonate.

### Example 24

The article according to any of Examples 21 to 23, further comprising at least one adhesive layer disposed between the first layer and the second layer or between the second layer and the third layer.

### Example 25

The article according to Example 24, wherein the at least one adhesive layer comprises epoxy, acrylate, amine, urethane, silicone, thermal plastic urethane, ethyl vinyl acetate, HALS free EVA, or a combination thereof.

### Example 26

The article according to any of Examples 21 to 25, wherein the laminate further comprises at least one functional layer.

### Example 27

The article according to Example 26, wherein the at least one functional layer is disposed between the first layer or the second layer or between the second layer and the at least one third layer.

### Example 28

The article according to Examples 26 or 27, wherein the at least one functional layer comprises an ultraviolet light protection layer, a touch sensing layer, an abrasion resistant layer, an infrared absorbing layer, an infrared reflecting layer, a hydrophobic layer, a hydrophilic layer, an anti-fingerprint layer, an anti-smudge layer, an antimicrobial layer, a conductive layer, an electromagnetic interference shielding layer, an anti-frost layer, an anti-fog layer, an image forming layer, or a combination thereof.

### Example 29

The article according to any of Examples 26 to 28, wherein the at least one functional layer comprises at least one of a film, a coating, a coextruded layer, a deposited layer or a molded layer.

### Example 30

The article according to any of Examples 26 to 29, further comprising at least one additional adhesive layer disposed between the at least one functional layer and at least one of the first layer, the second layer and the at least one third layer.

### Example 31

The article according to any of Examples 26 to 30, wherein the at least one additional adhesive layer comprises epoxy, acrylate, amine, urethane, silicone, thermal plastic urethane, ethyl vinyl acetate, HALS free EVA, or a combination thereof.

### Example 32

The article according to any of Examples 26 to 31, wherein the at least one functional layer comprises an image forming layer, a conductive layer or a touch sensing layer.

### Example 33

The article according to Example 32, wherein the image forming layer, conductive layer or touch sensing layer is a liquid crystal display.

### Example 34

The article according to any of Examples 21 to 33, wherein at least one of the first layer, the second layer or the at least one third layer is opaque.

### Example 35

The article according to any of Examples 21 to 34, wherein the polymeric material in the first layer or the third layer comprises polycarbonate, polyphenylene ether-polystyrene, polyetherimide, polybutylene terephthalate-polycarbonate, copolyestercarbonate, polyester, polyacrylate, polyamide, polyetherimide, polyphenylene ether, or a combination thereof.

### Example 36

The article according to any of any of Examples 21 to 35, wherein the first layer, the second layer or the third layer comprises a filler material.

### Example 37

The article according to Example 36, wherein the filler material comprises carbon fiber, glass fiber, aramid fiber, basalt fiber, quartz fiber, boron fiber, cellulose fiber, natural fiber, liquid crystal polymer fiber, high tenacity polymer fiber, or a combination thereof.

### Example 38

The article according to any of Examples 21 to 37, further comprising a molded component adhered to the laminate.

### Example 39

The article according to Example 38, further comprising an adhesive layer disposed between the laminate and the molded component.

### Example 40

The article according to any of Examples 21 to 39, wherein the article is an electronic device, a sound or moisture barrier, or a medical tray.

### Example 41

The article according to Example 40, wherein the article is an electronic device, the laminate further comprises at least one functional layer comprising a conductive layer or a touch sensing layer.

### Example 42

The article according to Example 41, the electronic device comprising a primary first surface and at least one second surface extending from the primary first surface at an angle, wherein the laminate overlies both the primary first surface and the at least one second surface such that the conductive layer or touch sensing layer is operable on both the primary first surface and the at least one second surface.

### Example 43

The article according to any of Examples 21 to 39, wherein the article is a sound or moisture barrier and comprises at least one third layer, and at least one of the first layer, the second layer and at least one third layer is opaque.

### Example 44

The article according to any of Examples 21 to 39, wherein the article is a medical tray comprising a base layer, and the laminate is thermoformed to the base layer.

### Example 45

The article according to Example 44, wherein the base layer comprises a polymeric material.

### Example 46

The article according to Example 45, wherein the polymeric material comprises a polyetherimide resin.

### Example 47

A method for making an article of manufacture, comprising thermoforming a glass sheet to a first layer comprising a polymeric material.

### Example 48

The method of Example 47, further comprising thermoforming at least one third layer comprising a polymeric material to the glass sheet.

### Example 49

The method according to Example 47 or 48, wherein the polymeric material in the first layer or the at least one third layer comprises polycarbonate.

### Example 50

The method according to any of Examples 47 to 49, further comprising applying at least one adhesive layer between the first layer and the glass sheet or between the glass sheet and the third layer.

### Example 51

The method according to Example 50, wherein the at least one adhesive layer comprises epoxy, acrylate, amine, urethane, silicone, thermal plastic urethane, ethyl vinyl acetate, HALS free EVA, or a combination thereof.

### Example 52

The method according to any of Examples 47 to 51, further comprising applying at least one functional layer to the laminate.

### Example 53

The method according to Example 52, wherein the at least one functional layer is disposed between the first layer or the glass sheet or between the glass sheet and the at least one third layer.

### Example 54

The method according to Examples 52 or 53, wherein the at least one functional layer comprises an ultraviolet light protection layer, a touch sensing layer, an abrasion resistant layer, an infrared absorbing layer, an infrared reflecting layer, a hydrophobic layer, a hydrophilic layer, an anti-fingerprint layer, an anti-smudge layer, an antimicrobial layer, a conductive layer, an electromagnetic interference shielding layer, an anti-frost layer, an anti-fog layer, an image forming layer, or a combination thereof.

### Example 55

The method according to any of Examples 52 to 54, wherein the at least one functional layer comprises at least one of a film, a coating, a coextruded layer, a deposited layer or a molded layer.

### Example 56

The method according to any of Examples 52 to 55, further comprising applying at least one additional adhesive layer between the at least one functional layer and at least one of the first layer, the glass sheet and the at least one third layer.

### Example 57

The method according to any of Examples 52 to 56, wherein the at least one additional adhesive layer comprises epoxy, acrylate, amine, urethane, silicone, thermal plastic urethane, ethyl vinyl acetate, HALS free EVA, or a combination thereof.

### Example 58

The method according to any of Examples 52 to 57, wherein the at least one functional layer comprises an image forming layer, a conductive layer or a touch sensing layer.

### Example 59

The method according to Example 58, wherein the image forming layer, conductive layer or touch sensing layer is a liquid crystal display.

### Example 60

The method according to any of Examples 47 to 59, wherein at least one of the first layer, the glass sheet or the at least one third layer is opaque.

### Example 61

The method according to any of Examples 47 to 60, wherein the polymeric material in the first layer or the third layer comprises polycarbonate, polyphenylene ether-polystyrene, polyetherimide, polybutylene terephthalate-polycarbonate, copolyestercarbonate, polyester, polyacrylate, polyamide, polyetherimide, polyphenylene ether, or a combination thereof.

### Example 62

The method according to any of any of Examples 47 to 61, wherein the first layer, the glass sheet or the third layer comprises a filler material.

### Example 63

The method according to Example 62, wherein the filler material comprises carbon fiber, glass fiber, aramid fiber, basalt fiber, quartz fiber, boron fiber, cellulose fiber, natural fiber, liquid crystal polymer fiber, high tenacity polymer fiber, or a combination thereof.

### Example 64

The method according to any of Examples 47 to 63, further comprising adhering a molded component to the laminate.

### Example 65

The method according to Example 64, further comprising applying an adhesive layer between the laminate and the molded component.

### Example 66

The method according to any of Examples 47 to 65, wherein the article is an electronic device, a sound or moisture barrier, or a medical tray.

### Example 67

The method according to Example 66, wherein the article is an electronic device, the laminate further comprises at least one functional layer comprising a conductive layer or a touch sensing layer.

### Example 68

The method according to Example 67, the electronic device comprising a primary first surface and at least one second surface extending from the primary first surface at an angle, wherein the laminate overlies both the primary first surface and the at least one second surface such that the conductive layer or touch sensing layer is operable on both the primary first surface and the at least one second surface.

### Example 69

The method according to any of Examples 47 to 65, wherein the article is a sound or moisture barrier and comprises at least one third layer, and at least one of the first layer, the glass sheet and at least one third layer is opaque.

### Example 70

The method according to any of Examples 47 to 65, wherein the article is a medical tray comprising a base layer, and the laminate is thermoformed to the base layer.

### Example 71

The method according to Example 70, wherein the base layer comprises a polymeric material.

### Example 72

The method according to Example 71, wherein the polymeric material comprises a polyetherimide resin.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A laminate comprising a first layer comprising a polymeric material and a second layer comprising a glass sheet thermoformed to the first layer.

2. The laminate of claim 1, further comprising at least one third layer comprising a polymeric material, the at least one third layer thermoformed to the second layer.

3. The laminate according to claim 1, wherein the polymeric material in the first layer or the at least one third layer comprises polycarbonate.

4. The laminate according to claim 1, further comprising at least one adhesive layer disposed between the first layer and the second layer or between the second layer and the third layer.

5. The laminate according to claim 4, wherein the at least one adhesive layer comprises epoxy, acrylate, amine, urethane, silicone, thermal plastic urethane, ethyl vinyl acetate, HALS free EVA, or a combination thereof.

6. The laminate according to claim 1, wherein the laminate further comprises at least one functional layer.

7. The laminate according to claim 6, wherein the at least one functional layer is disposed between the first layer or the second layer or between the second layer and the at least one third layer.

8. The laminate according to claim 6, wherein the at least one functional layer comprises an ultraviolet light protection layer, a touch sensing layer, an abrasion resistant layer, an infrared absorbing layer, an infrared reflecting layer, a hydrophobic layer, a hydrophilic layer, an anti-fingerprint layer, an anti-smudge layer, an antimicrobial layer, a conductive layer, an electromagnetic interference shielding layer, an anti-frost layer, an anti-fog layer, an image forming layer, or a combination thereof.

9. The laminate according to claim 6, wherein the at least one functional layer comprises at least one of a film, a coating, a coextruded layer, a deposited layer or a molded layer.

10. The laminate according to claim 6, further comprising at least one additional adhesive layer disposed between the at least one functional layer and at least one of the first layer, the second layer and the at least one third layer.

11. The laminate according to claim 6, wherein the at least one additional adhesive layer comprises epoxy, acrylate, amine, urethane, silicone, thermal plastic urethane, ethyl vinyl acetate, HALS free EVA, or a combination thereof.

12. The laminate according to claim 6, wherein the at least one functional layer comprises an image forming layer, a conductive layer or a touch sensing layer.

13. The laminate according to claim 12, wherein the image forming layer, conductive layer or touch sensing layer is a liquid crystal display.

14. The laminate according to claim 1, wherein at least one of the first layer, the second layer or the at least one third layer is opaque.

15. The laminate according to claim 1, wherein the polymeric material in the first layer or the third layer comprises polycarbonate, polyphenylene ether-polystyrene, polyetherimide, polybutylene terephthalate-polycarbonate, copolyestercarbonate, polyester, polyacrylate, polyamide, polyetherimide, polyphenylene ether, or a combination thereof.

16. The laminate according to claim 1, wherein the first layer, the second layer or the third layer comprises a filler material.

17. The laminate according to claim 16, wherein the filler material comprises carbon fiber, glass fiber, aramid fiber, basalt fiber, quartz fiber, boron fiber, cellulose fiber, natural fiber, liquid crystal polymer fiber, high tenacity polymer fiber, or a combination thereof.

18. An electronic device incorporating the laminate according to claim 1, wherein the electronic device comprises a mobile phone, an electronic tablet, an e-reader, a lap top computer, a desktop computer, a speaker, or a combination thereof.

19. A sound or moisture barrier incorporating the laminate according to claim 1.

20. A medical tray incorporating the laminate according to claim 1, wherein the laminate is thermoformed to the medical tray.
